(19) United States
(12) Patent Application Publication
(10) Pub. No.: US 2026/0321786 A1
(43) Pub. Date: Oct. 15, 2026

(54) BATTERY MODULE AND BATTERY COOLING SYSTEM

(71) Applicant: DENSO CORPORATION, Kariya-shi (JP)

(72) Inventors: Kimio KOHARA, Kariya-city (JP); Kenshiro Muramatsu, Kariya-city (JP); Takahito Shibata, Kariya-city (JP); Hisashi Umemoto, Kariya-city (JP); Yasuyuki Oba, Kariya-city (JP); Yuji Yamagami, Kariya-city (JP); Hiroyuki Furuya, Kariya-city (JP)

(21) Appl. No.: 19/696,687

(22) Filed: Jun. 3, 2026

Related U.S. Application Data
(63) Continuation of application No. PCT/JP2024/036397, filed on Oct. 11, 2024.

(30) Foreign Application Priority Data
Dec. 5, 2023 (JP) 2023-205557

(51) Int. Cl. H01M 10/6557; H01M 10/613; H01M 10/625; H01M 10/63; H01M 10/653; H01M 10/6568; H01M 50/204; H01M 50/249

(52) U.S. Cl. CPC H01M 10/6557; H01M 10/613; H01M 10/625; H01M 10/63; H01M 10/653; H01M 10/6568; H01M 50/249; H01M 50/204

(57) ABSTRACT

A heat storage part is at a position between adjacent battery cells, exchanges heat with battery cells and stores heat of the battery cells. A cooling fluid passage is provided at a position between the battery cells and the heat storage part that are adjacent to each other, through which supplied cooling fluid is flowable. The battery cell and the heat storage part are connected via at least two connection members. A gap is formed at a part between the battery cell and the heat storage part to which the battery cell and the heat storage part are not connected via the connection member. The cooling fluid passage is formed as a gap between the adjacent connection members.

### CROSS REFERENCE TO RELATED APPLICATION

The present application is a continuation application of International Patent Application No. PCT/JP 2024/036397 filed on Oct. 11, 2024, which designated the U.S. and claims the benefit of priority from Japanese Patent Application No. 2023-205557 filed on Dec. 5, 2023. The entire disclosures of all of the above applications are incorporated herein by reference.

### TECHNICAL FIELD

The present disclosure relates to a battery module and a battery cooling system.

### BACKGROUND

Conventionally, a battery module including battery cells have been known.

### SUMMARY

According to an aspect of the present disclosure, a battery module comprises: a plurality of battery cells; and an accommodation part accommodating the battery cells. The battery module may further comprise: a heat storage part provided at a position between the battery cells, which are adjacent to each other, and configured to exchange heat with the battery cells and store heat of the battery cells; a valve joint provided to the accommodation part, the valve joint detachable and attachable to a cooling device, which is configured to supply cooling fluid to the accommodation part; and a cooling fluid passage provided at a position between the battery cell and the heat storage part, which are adjacent to each other, the cooling fluid passage configured to allow cooling fluid, which is supplied to the accommodation part, to flow therethrough. The battery cell and the heat storage part may be connected with each other via at least two connection members. A portion of the battery cell and a portion of the heat storage part, which are not connected with each other via the connection members, may define a gap therebetween. The gap defined between the connection members, which are adjacent to each other, may form the cooling fluid passage.

### BRIEF DESCRIPTION OF THE DRAWINGS

FIG. 1 is a diagram of a schematic configuration of an eVTOL according to a first embodiment.

FIG. 2 is an explanatory diagram of a battery cooling system during flight according to the first embodiment.

FIG. 3 is a top view of a battery module during flight according to the first embodiment.

FIG. 4 is an explanatory diagram of the battery cooling system on a ground according to the first embodiment.

FIG. 5 is a top view of the battery module on the ground according to the first embodiment.

FIG. 6 is a diagram of changes in battery output and battery temperature from takeoff to landing of the eVTOL according to the first embodiment.

FIG. 7 is a top view of the battery module during flight according to a modified example.

FIG. 8 is an explanatory diagram of the battery cooling system on the ground according to a second embodiment.

FIG. 9 is an explanatory diagram of the battery cooling system on the ground according to the second embodiment.

FIG. 10 is an explanatory diagram of the battery cooling system on the ground according to a third embodiment.

FIG. 11 is an explanatory diagram of the battery cooling system on the ground according to the third embodiment.

FIG. 12 is a top view of the battery module during flight according to a fourth embodiment.

FIG. 13 is a top view of the battery module during flight according to a fifth embodiment.

FIG. 14 is a top view of the battery module during flight according to a sixth embodiment.

FIG. 15 is a top view of the battery module during flight according to a modified example.

### DETAILED DESCRIPTION

Hereinafter, examples of the present disclosure will be described.

According to an example of the present disclosure, a battery module has a heat receiving unit sandwiched between battery cells to receive heat of the battery cells, and a cooling unit that protrudes from the battery cells and is formed integrally with the heat receiving unit. This configuration enable heat of the battery cells to be efficiently dissipated by supplying a cooling fluid to a cooling unit.

Incidentally, when a battery module is mounted on, for example, an electric flying object, the cooling capacity required differs between when the electric flying object is in flight and when it is on the ground after landing. That is, since electric flying objects are required to be lightweight when flying, it is necessary to simplify the configuration required for cooling the battery pack while ensuring a minimum level of cooling capacity. On the other hand, when the electric aircraft is on the ground, high-performance cooling is required to deal with heat generated by rapid charging of the battery pack.

A battery module according to an example of the present disclosure includes: a plurality of battery cells; an accommodation part accommodating the battery cells; a heat storage part provided at a position between the battery cells, which are adjacent to each other, and configured to exchange heat with the battery cells and store heat of the battery cells; a valve joint provided to the accommodation part, the valve joint detachable and attachable to a cooling device, which is configured to supply cooling fluid to the accommodation part; and a cooling fluid passage provided at a position between the battery cell and the heat storage part, which are adjacent to each other, the cooling fluid passage configured to allow cooling fluid, which is supplied to the accommodation part, to flow therethrough. The battery cell and the heat storage part are connected with each other via at least two connection members. A portion of the battery cell and a portion of the heat storage part, which are not connected with each other via the connection members, define a gap therebetween. The gap defined between the connection members, which are adjacent to each other, form the cooling fluid passage.

Further, a battery cooling system according to an example of the present disclosure includes: a battery module including a plurality of battery cells, an accommodation part accommodating the battery cells, a heat storage part provided at a position between the battery cells, which are adjacent to each other, and configured to exchange heat with the battery cells and store heat of the battery cells, and a valve joint provided to the accommodation part, the valve joint detachable and attachable to a cooling device, which is configured to supply cooling fluid to the accommodation part; the cooling device configured to cool and store cooling fluid; and a control device configured to control the cooling device. The battery module and the cooling device are configured to, when connected with each other via the valve joint, form a cooling circulation circuit that is configured to circulate cooling fluid between the battery module and the cooling device. The control device is configured to circulate cooling fluid, which is cooled in advance by the cooling device, through the cooling circulation circuit, and after circulating cooling fluid, discharge at least a part of cooling fluid in the accommodation part through the cooling circulation circuit.

Further, a battery cooling system according to an example of the present disclosure includes: a battery module including a plurality of battery cells, an accommodation part accommodating the battery cells, a heat storage part provided at a position between the battery cells, which are adjacent to each other, and configured to exchange heat with the battery cells and store heat of the battery cells, and a valve joint provided to the accommodation part, the valve joint detachable and attachable to a cooling device, which is configured to supply cooling fluid to the accommodation part; the cooling device configured to cool and store cooling fluid; and a control device configured to control the cooling device. The battery module and the cooling device are configured to, when connected with each other via the valve joint, form a cooling flow path that is configured to allow cooling fluid to flow between the battery module and the cooling device. The control device is configured to fill the battery module with cooling fluid, which is cooled in advance by the cooling device, from the cooling device through the cooling flow path, and after filling of cooling fluid, discharge at least a part of cooling fluid in the accommodation part through the cooling flow path.

According to the above, when the cooling device is not connected to the valve joint, heat storage cooling is performed, in which heat from each of the battery cells is absorbed by the heat storage part. On the other hand, when the cooling device is connected to the valve joint, immersion cooling is performed, in which the battery cells are immersed in the cooling fluid and cooled. Therefore, by simply attaching or detaching the cooling device to or from the valve joint, it is possible to switch the cooling method for cooling the battery cells and to adjust the cooling capacity for the battery cells. Therefore, it is possible to easily adjust the cooling capacity for the battery cells.

Hereinafter, embodiments for carrying out the present disclosure are described with reference to the drawings. In each embodiment, parts corresponding to the items described in the preceding embodiment(s) are denoted by the same reference numerals, and redundant explanation may be omitted. When only a part of a configuration is described in an embodiment, the other preceding embodiment(s) can be applied to the other parts of such configuration.

When, in each embodiment, it is explicitly described that parts are combinable, combination of such parts is possible. Further, even when it is not explicitly described that combination of embodiments are possible, such a combination of the embodiments is possible, provided that such a combination does not cause any hindrance.

### First Embodiment

The battery module according to the present embodiment is mounted on an electric mover. The electric mover is an electric flying object, an electric vehicle, or the like. An electric flying object can fly by driving a rotating electric machine.

Examples of the electric flying object include an electric vertical take-off and landing aircraft (eVTOL), an electric short take-off and landing aircraft (eSTOL), a drone and the like. The eVTOL is an abbreviation of an electric Vertical Take-Off and Landing aircraft. The eSTOL is an abbreviation of an electronic Short distance Take-Off and Landing aircraft. In the following, an example in which a battery module is mounted on an eVTOL will be described.

### eVTOL

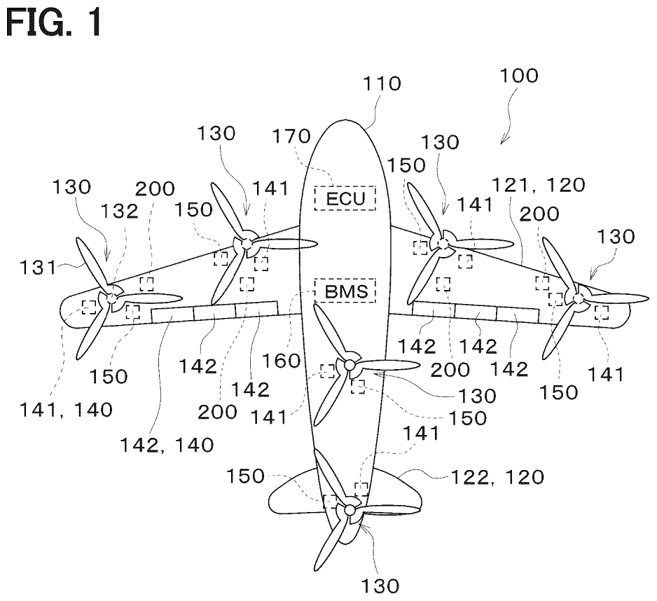

As shown in FIG. 1, as an example, an eVTOL 100 of the present embodiment includes an aircraft body 110, fixed wings 120, rotors 130, a lift adjustment mechanism 140, a battery module 200, an EPU 150, a BMS 160, and an ECU 170.

The aircraft body 110 is a fuselage of the aircraft. The aircraft body 110 has a shape that extends in the front-rear direction. The aircraft body 110 includes a passenger compartment for passengers and/or a luggage compartment for carrying luggage.

The fixed wing 120 is a wing portion of the aircraft and is connected to the aircraft body 110. The fixed wings 120 provide gliding lift. Gliding lift is a lift generated by the fixed wing 120. As an example, the fixed wing 120 includes a main wing 121 and a tail unit 122. The main wing 121 extends from the center of the aircraft body 110 in the longitudinal direction to the left and right. The tail unit 122 extends to the left and right from the rear of the aircraft body 110. The shape of the fixed wing 120 is not particularly limited. For example, swept-back wings, delta wings, straight wings, etc. may be employed.

Multiple rotors 130 are provided on the aircraft body. At least some of the multiple rotors 130 may be provided on the fixed wing 120. At least some of the multiple rotors 130 may be provided on the aircraft body body 110. The number of rotors 130 included in eVTOL 100 is not particularly limited. As an example, multiple rotors 130 are provided on each of the aircraft body 110 and the main wing 121. The eVTOL 100 includes six rotors 130.

The rotors 130 may also be referred to as a rotor, a propeller, a fan, or the like. The rotor 130 includes a blade 131 and a shaft 132. The blades 131 are attached to the shaft 132. The blade 131 is a vane that rotates together with the shaft 132. The blades 131 extend radially around an axis of the shaft 132. The shaft 132 is a rotation axis of the rotor 130 and is driven to rotate by a motor of the EPU 150.

The rotor 130 generates propulsive force by rotation. The propulsive force acts on the eVTOL 100 primarily as rotational lift when the eVTOL 100 takes off or lands. The rotor 130 primarily provides rotational lift during takeoff and landing. Rotational lift is a lift generated by the rotation of the rotor 130. During takeoff and landing, the rotor 130 may provide rotational lift alone, or may provide rotational lift as well as forward thrust. The rotor 130 provides rotational lift when eVTOL 100 is hovering.

The propulsive force acts on eVTOL 100 primarily as thrust during cruise of the eVTOL 100. The rotor 130 primarily provides thrust during cruise. During cruise, the rotor 130 may provide thrust alone or may provide lift in addition to thrust.

The lift adjustment mechanism 140 adjusts the gliding lift of the fixed wing 120. The lift adjustment mechanism 140 increases or decreases the gliding lift generated by the fixed wing 120. The lift adjustment mechanism 140 adjusts the gliding lift by adjusting, for example, at least one of a surface area, an angle of attack (AOA), a camber (wing curvature), a stall AOA, and a wing speed of the fixed wing 120. The AOA is an abbreviation of an angle of attack. As an example, the lift adjustment mechanism 140 includes a tilt mechanism 141 and a flap 142.

The tilt mechanism 141 is driven to adjust a tilt angle of the rotor 130. The tilt mechanism 141, together with a motor and an inverter that drive the tilt mechanism 141, constitutes a tilt adjustment device. The tilt adjustment device including the tilt mechanism 141 is provided individually for each rotor 130, for example. The tilt mechanism 141 adjusts the tilt angle of the rotor 130 by adjusting a relative inclination of the rotor 130 with respect to the aircraft.

During takeoff and landing, the tilt mechanism 141 controls the tilt angle so that an axis of each rotor 130 approaches a position parallel to a top-bottom direction. In such manner, the propulsive force generated by the rotation of each rotor 130 acts on the eVTOL 100 primarily as rotational lift. Therefore, the eVTOL 100 can take off and land in a short distance or vertically. In FIG. 1, the top-bottom direction is a direction perpendicular to the paper surface.

During cruising, the tilt mechanism 141 controls the tilt angle so that the axis of each rotor 130 approaches a position parallel to the horizontal direction. In such manner, the propulsive force generated by the rotation of each rotor 130 acts on the eVTOL 100 primarily as thrust. Therefore, the eVTOL 100 can move forward using the forward thrust generated by the rotation of each rotor 130 while obtaining gliding lift from the fixed wing 120. In addition, the gliding lift can be adjusted by changing the wing velocity with thrust.

Although the tilt mechanism 141 is provided separately for the rotor 130 in the example shown, the present embodiment is not limited to the above. For example, the tilt angles of multiple rotors 130 arranged side by side may be controlled by a common tilt mechanism. The rotor 130 may be integrated with a part of the wing portion, and the part of the wing portion and the rotor 130 may be displaced integrally by a tilt mechanism.

The flap 142 is a movable wing piece and is provided on the fixed wing 120. The flap 142, together with a motor, an inverter, and the like that drive the flap 142, constitutes a flap adjustment device. The flap 142 may be referred to as a high-lift device. As an example, multiple flaps 142 are provided at a rear edge of the main wing 121. A motor and an inverter are provided in each of the multiple flaps 142. The flap 142 may be provided on the tail unit 122 in addition to the main wing 121. The flap 142 may be provided on a front edge of the fixed wing 120.

The flap 142 adjusts the surface area and camber of the fixed wing 120. For example, by controlling the flaps 142 provided on the main wing 121 to a lower position, the gliding lift acting on the main wing 121 increases. By moving the flaps 142 in a direction protruding from the main wing 121, the gliding lift can also be further increased.

The lift adjustment mechanism 140 is not limited to the tilt mechanism 141 and the flap 142 described above. The lift adjustment mechanism 140 may be a tilt mechanism that adjusts the relative tilt of the fixed wing 120 with respect to the aircraft body 110. In such case, the angle of attack of the fixed wing 120 can be adjusted. The lift adjustment mechanism 140 may be a rotor for thrust provided separately from the rotor 130. In such case, the wing speed can be adjusted. Further, by providing a rotor for thrust, the rotor 130 can be dedicated to the lift (i.e., rotational lift).

A variable wing may be used as the lift adjustment mechanism 140. Lift can be adjusted by changing the surface area, camber, attachment angle, etc. of the fixed wing 120. The lift adjustment mechanism 140 may be a high-lift device other than the flap 142, such as a slat. The slat is provided at the front edge of the main wing 121. By moving the slat forward with respect to the main wing 121, a gap can be formed between the slat and the main wing 121, to delay separation. Thus, the lift can be increased up to a higher angle of attack without stalling. That is, the stall AOA can be delayed.

The battery module 200 is a device that has multiple battery cells, which will be described later, and is capable of cooling each of the battery cells. Each battery cell is a rechargeable secondary battery that can store DC power. Each battery cell supplies electric power to the EPU 150, the ECU 170, the tilt adjustment device, and the flap adjustment device. Further, each battery cell supplies electric power to auxiliary equipment (not shown), such as an air conditioner and the like.

As an example, the eVTOL 100 of the present embodiment includes multiple battery modules 200. Multiple battery modules 200 may be connected to each other in series and/or parallel, or may be arranged independently without being connected to each other. The battery module 200 may be provided separately for the EPU 150 or may be provided redundantly for the EPU 150.

Here, since the battery module 200 includes, for example, several tens or several hundreds of battery cells, the weight of the battery module 200 is large. Therefore, by arranging each battery module 200 at two positions on each side of the main wing 121, the aircraft body 110 can be balanced. Of course, the battery module 200 may be provided in the aircraft body 110.

The EPU 150 includes a motor and an inverter, and rotates and drives the rotor 130 that provides propulsive force to the eVTOL 100. The EPU is an abbreviation of Electric Propulsion Unit. For example, the number of EPUs 150 provided is the same as the number of rotors 130. In other words, the eVTOL 100 includes six EPUs 150. The EPU 150 and the rotor 130 are connected in a one-to-one relationship. Alternatively, two or more rotors 130 may be connected to one EPU 150 via a gearbox.

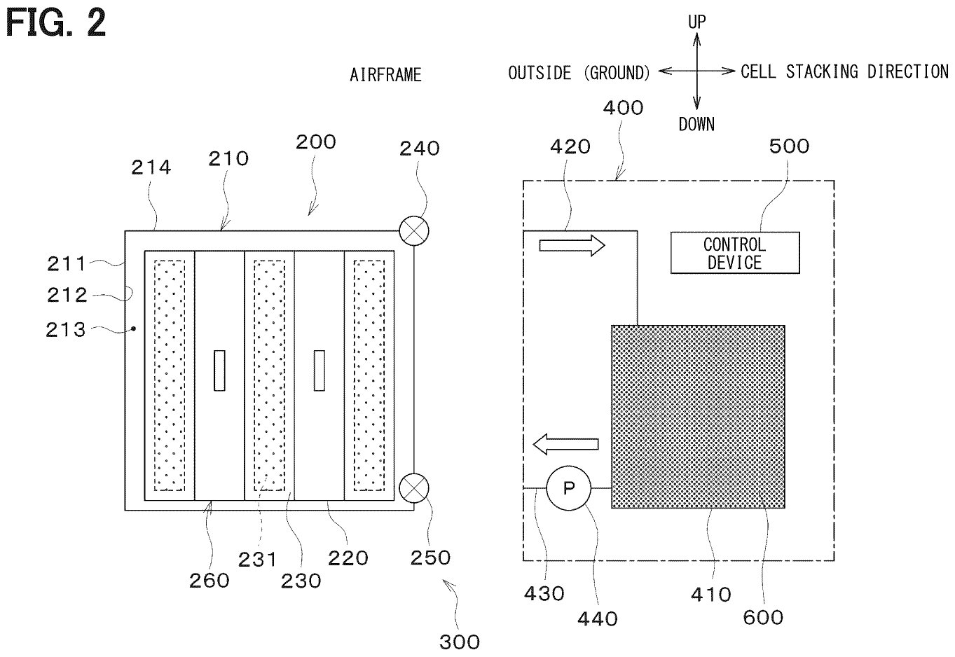

The BMS 160 monitors the state of each battery pack 260 (see FIG. 2 described below) of the battery module 200. The BMS is an abbreviation of a Battery Management System. For example, one BMS 160 is provided for one battery module 200. The BMS 160 may, for example, predict or detect an abnormality in each battery module 200 by monitoring the state of each battery pack 260 in each of multiple battery modules 200.

The ECU 170 controls the flight of the eVTOL 100. The ECU is an abbreviation of Electronic Control Unit. The ECU 170 controls the eVTOL 100 to fly in a flight state according to operation by a pilot as an operator, remote operation by an operator, or control by a control system. The ECU 170 performs flight control based on the detection results of the BMS 160 and various sensors. The ECU 170 controls the driving of, for example, the motor of the EPU 150, the motor of the tilt adjustment device, and the motor of the flap adjustment device. The ECU 170 may also control the auxiliary equipment.

### Battery Cooling System

As shown in FIG. 2, a battery cooling system 300 of the present embodiment includes the battery module 200, a cooling device 400, and a control device 500. The up and down directions when the eVTOL 100 is stationary on the ground are referred to as the top-bottom direction. In the top-bottom direction, the top side points to the sky and the bottom side points to the ground. The top-bottom direction corresponds to the direction of gravity.

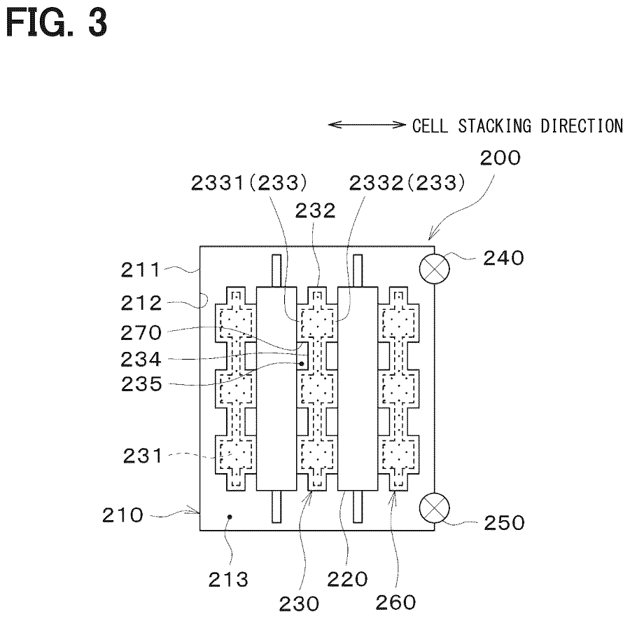

As shown in FIGS. 2 and 3, the battery module 200 of the present embodiment includes a cooling bath 210, multiple battery cells 220, a heat storage tube 230, and valve joints 240 and 250.

The cooling bath 210 is an accommodation part that accommodates the battery cells 220 and the heat storage tubes 230. The cooling bath 210 constitutes a housing of the battery module 200. The cooling bath 210 includes an outer wall surface 211 and an inner wall surface 212, and also includes a space 213 inside. The cooling bath 210 is made of, for example, a metal material such as aluminum or a resin material. As an example, the cooling bath 210 of the present embodiment is made of an aluminum-based material.

The cooling bath 210 may have a lid part 214 formed on the top side in the top-bottom direction, for example. The lid part 214 can be attached to and detached from the other parts. In such manner, the multiple battery cells 220 and the multiple heat storage tubes 230 can be inserted into and removed from the space 213 of the cooling bath 210. Further, the inside of the cooling bath 210 may be sealed, or may be not completely sealed.

The battery cell 220 is a secondary battery that generates an electromotive force through a chemical reaction. The battery cell 220 is, for example, a lithium ion secondary battery, a nickel-metal hydride secondary battery, an organic radical battery, or the like. The battery cell 220 may be a secondary battery with a liquid electrolyte, or may be a so-called all-solid-state battery with a solid electrolyte.

Multiple battery cells 220 are accommodated in the space 213 of the cooling bath 210. Multiple battery cells 220 have a common structure. The number and arrangement of multiple battery cells 220 are not particularly limited. Multiple battery cells 220 may be connected in series, or may be connected in both parallel and series. As an example, the battery cells 220 in the present embodiment are connected in series. An electrically-connected structure of multiple battery cells 220 is sometimes called as a battery pack.

The battery cell 220 includes a power generating element and a battery case that accommodates the power generating element. The battery case provides an outer shell for the battery cell 220. The battery case is made of, for example, a metal material. The shape of the battery cell 220, that is, the battery case, is not particularly limited. The battery case may have a cylindrical shape, or a rectangular shape. As an example, the battery cell 220 of the present embodiment has a rectangular shape, specifically a thin, flat shape.

The battery cell 220 is, for example, a laminated battery. The battery cell 220 has a top surface, a bottom surface, and four side surfaces. The top surface is a surface facing upward in the top-bottom direction. The bottom surface is a surface opposite to the top surface in the top-bottom direction and faces the ground. The side surface is a surface that connects the top surface and the bottom surface, and extends in the top-bottom direction. As an example, multiple battery cells 220 in the present embodiment are arranged side by side in a direction perpendicular to the top-bottom direction.

Each battery cell 220 includes two electrode terminals. One of the electrode terminals is electrically connected to the positive electrode of the battery cell 220. One of the electrode terminals may be referred to as a positive electrode terminal, a P terminal, or the like. The other electrode terminal is electrically connected to the negative electrode of the battery cell 220. The other electrode terminal may be referred to as a negative electrode terminal, an N terminal, or the like. The electrode terminals may be referred to as current collecting tabs.

The heat storage tube 230 is provided at a position between adjacent battery cells 220. The heat storage tube 230 is a heat transfer member that gives heat to and receives heat from the battery cell 220. Further, the heat storage tube 230 is a heat storage part in which a heat storage material 231 is put. That is, the inside of the heat storage tube 230 is filled with the heat storage material 231.

The heat storage material 231 is a member that exhibits a heat storage effect. The heat storage material 231 cools the battery cells 220 by absorbing heat generated in the battery cells 220. The heat storage material 231 is, for example, a latent heat storage material. As the heat storage material 231, water or cooling water to which LLC has been added may be used instead of the latent heat storage material. LLC is an abbreviation of Long Life Coolant. The heat storage material is sometimes called a cold storage material.

As an example, the heat storage material 231 in the present embodiment is a latent heat storage material. The latent heat storage material is sometimes referred to as PCMs. PCM is an abbreviation of Phase Change Material. The latent heat storage material changes phase between solid and liquid. Phase change materials utilize the latent heat of a substance. The latent heat storage material maintains the temperature of the battery cell 220 at a predetermined temperature or within a predetermined temperature range. As the latent heat storage material, for example, a non-hydrate carbon compound, specifically a paraffin compound, may be used. As the latent heat storage material, a hydrate-based material may be used instead of a paraffin-based material. Hydrates include, for example, hydrates of sodium acetate, sodium sulfate, sodium nitrate, and the like.

As an example, the heat storage material 231 in the present embodiment is a non-hydrate carbon compound, that is, a paraffin-based heat storage material. The phase transition temperature of the heat storage material 231 between the solid phase and the liquid phase is set within a range of 30 degrees in Celsius to 60 degrees in Celsius.

Multiple heat storage tubes 230 are arranged in the space 213 of the accommodation part 210. As an example, in the present embodiment, one heat storage tube 230 is provided at a position between each pair of adjacent battery cells 220.

The heat storage tube 230 and the battery cell 220 are in thermal contact with each other. The heat storage tube 230 will be described in detail later.

The battery pack 260 is made up of multiple battery cells 220 and heat storage tubes 230 stacked as described above. Hereinafter, the stacking direction of the battery cells 220 in the battery pack 260 will be referred to as a cell stacking direction.

Multiple battery cells 220 and multiple heat storage tubes 230 are arranged so that the positions of their upper surfaces are substantially equal to each other in the top-bottom direction. The relative positions of multiple battery cells 220 and multiple heat storage tubes 230 are fixed by a fixing member (not shown). The fixing member may be, for example, a case or a restraining member such as a belt-like band.

In the above-described arrangement, the electrode terminals of adjacent battery cells 220 are electrically connected to each other by bus bars (not shown) that are wiring members. In other words, multiple battery cells 220 are connected in series by the bus bars.

Two bus bars, one for a positive electrode and one for a negative electrode, protrude from the space 213 of the cooling bath 210 to the outside of the cooling bath 210. When the cooling bath 210 is made of a metal material, an insulating part (not shown) such as an insulating sealant or the like is placed at the portion of the cooling bath 210 through which the bus bar passes, thereby achieving electrical insulation and sealing between the cooling bath 210 and the bus bar.

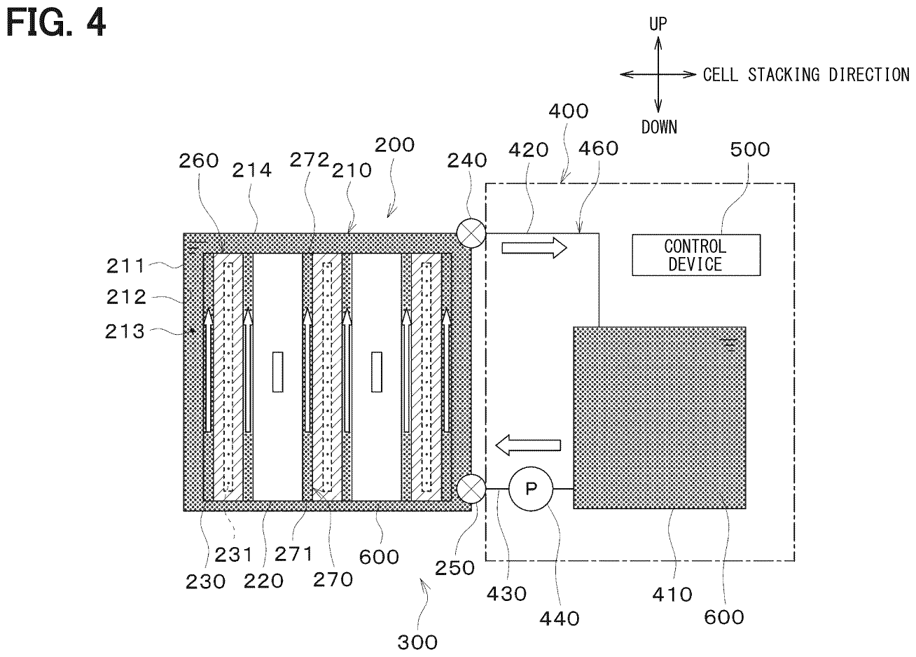

As shown in FIG. 4, the valve joints 240 and 250 are, respectively, an attach-detach unit to which the cooling device 400 is detachably attached. That is, the cooling bath 210 is attached to and detached from the cooling device 400 via the valve joints 240 and 250. The valve joints 240 and 250 allow the passage of a cooling fluid 600 when connected to the cooling device 400, but block the passage of the cooling fluid 600 when not connected to the cooling device 400. The cooling fluid 600 will be described in detail later.

For example, the valve joints 240, 250 are manually switched to an open state after the cooling device 400 is connected. Further, the valve joints 240, 250 are manually switched to a closed state before the connection to the cooling device 400 is released. Alternatively, the valve joints 240, 250 may be mechanically switched to the open state when connected to the cooling device 400. Further, the valve joints 240, 250 may be mechanically switched to the closed state when disconnected from the cooling device 400.

Here, the center position of the cooling bath 210 in the top-bottom direction is defined as a reference position. In the present embodiment, one of the valve joints 240 is provided above the reference position in the cooling bath 210. The other valve joint 250 is provided below the reference position in the cooling bath 210.

Hereinafter, the valve joint 240 provided above the reference position in the cooling bath 210 will also be referred to as a first valve joint 240. The valve joint 250 provided below the reference position in the cooling bath 210 is also referred to as a second valve joint 250.

In such manner, for example, when the cooling fluid 600 inside the cooling bath 210 is discharged to the outside via the second valve joint 250, the cooling fluid 600 can be discharged from the cooling bath 210 to the outside by gravity. In such case, the cooling fluid 600 positioned above the second valve joint 250 in the top-bottom direction can be discharged to the outside.

It should be noted that both of the first valve joint 240 and the second valve joint 250 may be provided below the reference position of the cooling bath 210 in the top-bottom direction. Alternatively, both of the first valve joint 240 and the second valve joint 250 may be provided above the reference position of the cooling bath 210 in the top-bottom direction. In other words, it is sufficient that the first valve joint 240 and the second valve joint 250 are each provided at a position in the cooling bath 210 where the cooling fluid 600 is present.

By arranging the valve joints 240, 250 so that they are offset from each other in the top-bottom direction or horizontal direction, it is possible to discharge a greater amount of the cooling fluid 600 from the cooling bath 210 or circulate with less stagnation amount thereof (i.e., non-flowing portions). Further, each of the valve joints 240 and 250 may be connected to the cooling bath 210 via a pipe.

The cooling device 400 is a device that cools and stores the cooling fluid 600. The cooling device 400 is a device that allows the cooling fluid 600 inside the cooling bath 210 to flow in and out, via connection to the valve joints 240 and 250 of the cooling bath 210.

The cooling fluid 600 is a heat medium that is supplied to the space 213 of the cooling bath 210 when the cooling device 400 is connected to the valve joints 240 and 250 of the cooling bath 210. The cooling fluid 600 is a cooling fluid in which each battery cell 220 is immersed, absorbing heat from each battery cell 220 to cool each battery cell 220 when the cooling device 400 is connected to the valve joints 240, 250 of the cooling bath 210.

When the cooling device 400 is connected to the valve joints 240, 250, the whole battery cell 220 may be immersed in the cooling fluid 600, or only a part of the battery cell 220 may be immersed in the cooling fluid 600. As an example, in the present embodiment, each battery cell 220 is wholly immersed in the cooling fluid 600.

In the present embodiment, an insulating liquid having insulating properties is used as the cooling fluid 600. As the insulating liquid, for example, a non-flammable fluorine-based liquid can be used. Non-flammable means that a substance or object does not burn and does not easily spread fire induced by sparks or heat, i.e., has non-flammable nature. The non-flammable fluorine-based insulating liquid can suppress thermal chain reaction when the battery cell 220 experiences thermal runaway, or can even prevent thermal chain reaction itself. In other words, fluorine-based insulating liquids have the advantage of being highly safe.

Examples of non-flammable fluorine-based insulating liquids that can be used include Galden (registered trademark) manufactured by Solvay, Asahiklin (registered trademark) manufactured by AGC, and Opteon (registered trademark) manufactured by Chemours.

Another example of the insulating liquid is oil. Since oil has low volatility, there is little leakage from the cooling bath 210 to the outside. Further, oil is cheaper than the above-mentioned fluorine-based insulating liquid.

As the oil, for example, SPECTRASYN (registered trademark) from ExxonMobil Corporation, SYNFLUID (registered trademark) from Chevron Phillips Chemical Company, or MIVOLT (registered trademark) from M&I Materials can be used. Other oils that can be used include, for example, AmpCool from Engineered Fluids and silicone oil from Shin-Etsu Chemical Co., Ltd.

The cooling device 400 of the present embodiment includes a tank 410, pipes 420 and 430, and a pump 440. The tank 410 stores the cooling fluid 600. The pipes 420 and 430 are connected to the tank 410. The pump 440 pumps the cooling fluid 600 in the tank 410 to the pipe 430. Although not shown, the cooling device 400 also includes a cooling facility for cooling and maintaining the temperature of the cooling fluid 600 in the tank 410.

The pipes 420 and 430 are, for example, hoses. One of the pipes 420 is connected to the first valve joint 240. The other pipe 430 is connected to the second valve joint 250. In such manner, by connecting the battery module 200 and the cooling device 400 via the valve joints 240, 250 and the pipes 420, 430, a cooling circulation circuit 460 is formed in which the cooling fluid 600 can circulate between the battery module 200 and the cooling device 400.

The other pipe 430 may be provided with a discharge valve for discharging the high-temperature cooling fluid 600 from the cooling bath 210. In such manner, the high-temperature cooling fluid 600 inside the cooling bath 210 can be quickly discharged. Of course, the discharge valve does not have to be provided on the other pipe 430.

The cooling device 400 is provided for each battery module 200, for example. Alternatively, a single cooling device 400 may have multiple sets of pipes 420 and 430 arranged in parallel. In such case, each of the pipes 420 and 430 is connected to each of the battery modules 200.

The cooling device 400 is connected to the cooling bath 210 after the eVTOL 100 has landed (i.e., when on the ground). As shown in FIG. 2, when the eVTOL 100 is taking off, cruising, or landing (i.e., in flight), the battery module 200 is detached from the cooling device 400 and is positioned in an airframe of the eVTOL 100. The cooling system 400 is positioned outside the eVTOL 100.

It should be noted that cooling device 400 may be connected to the cooling bath 210 at the same time as the eVTOL 100 lands. Additionally, the cooling device 400 may be configured to be detached from the cooling bath 210 simultaneously at the take-off of the eVTOL 100.

The control device 500 is a device that controls the cooling device 400. The control device 500 controls, for example, the rotation speed (i.e., pumping capacity) of the pump 440 and the cooling temperature of the cooling facility. The control device 500 is composed of a well-known microcomputer including a processor, ROM, RAM, etc., and its peripheral circuits. The control device 500 performs various calculations and processes based on a control program stored in the ROM.

When multiple cooling devices 400 are provided, the control device 500 may be provided for each battery module 200, or one control device 500 may control multiple battery modules 200.

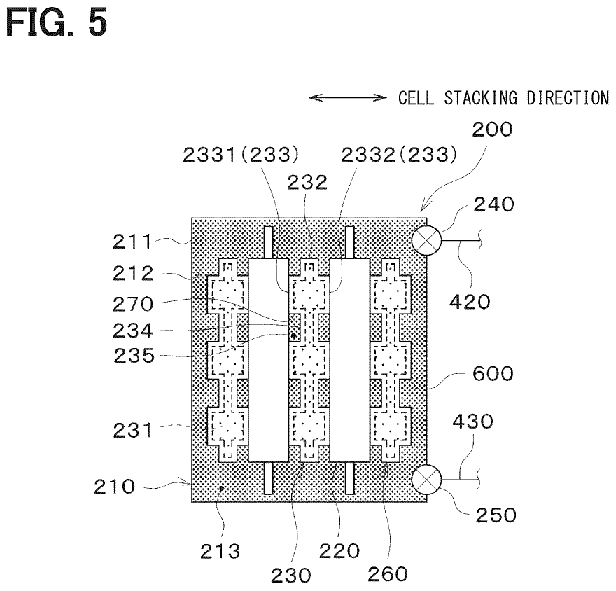

As shown in FIGS. 3 and 5, a cooling fluid passage 270 is provided at a position between adjacent battery cells 220 and heat storage tubes 230. The cooling fluid passage 270 is a passage through which the cooling fluid 600 can flow when the eVTOL 100 is on the ground, i.e., when the cooling device 400 is connected to the valve joints 240 and 250.

As an example, the heat storage tube 230 of the present embodiment has a base unit 232 and multiple protrusions 233. The base unit 232 does not contact the battery cell 220. The base unit 232 extends in a direction perpendicular to the cell stacking direction. In the present embodiment, for example, the base unit 232 extends in the top-bottom direction (the direction perpendicular to the paper surfaces of FIGS. 3 and 5).

The base unit 232 faces the battery cell 220, and includes a non-contact surface 234 that is not in contact with the battery cell 220. In other words, the surface of the base unit 232 that faces the battery cell 220 has the non-contact surface 234 that is not in contact with the battery cell 220.

The multiple protrusions 233 are each formed to protrude from the non-contact surface 234 of the base unit 232 toward the adjacent battery cells 220. The protrusion 233 is in contact with the surface of the battery cell 220. In other words, the surfaces of adjacent battery cells 220 and the surfaces of the heat storage tubes 230 are connected via at least two protrusions 233. Therefore, the protrusion 233 in the present embodiment corresponds to an example of a connection member.

A gap 235 is formed at positions between the battery cell 220 and the heat storage tube 230, at which the battery cell 220 and the heat storage tube 230 are not connected via the protrusion 233. The gap 235 formed between adjacent protrusions 233 configures cooling fluid passages 270. More specifically, the cooling fluid passage 270 is formed by the gap 235, which is surrounded by (a) two adjacent protrusions 233, (b) the non-contact surface 234 between two protrusions 233, and (c) the surface of the battery cell 220 facing the non-contact surface 234.

In the present embodiment, as an example, the base unit 232 and multiple protrusions 233 are integrally formed. The space in the base unit 232 that accommodates the heat storage material 231 and the space in each of the protrusions 233 that accommodates the heat storage material 231 are in communication with each other. In such manner, by simply providing a filling port (not shown) for filling the heat storage tube 230 with the heat storage material 231 in one position, the heat storage tube 230 can be filled with the heat storage material 231 and sealed. That is, there is no need to provide multiple filling ports. Therefore, the configuration of the heat storage tube 230 can be simplified.

As shown in FIG. 4, the cooling fluid passage 270 includes an inlet 271 through which the cooling fluid 600 flows to the cooling fluid passage 270, and an outlet 272 through which the cooling fluid 600 flows out of the cooling fluid passage 270. The inlet 271 and the outlet 272 are provided at different positions. That is, the cooling fluid passage 270 penetrates in one direction. The cooling fluid passage 270 extends linearly.

In the present embodiment, as an example, the cooling fluid passage 270 extends in the top-bottom direction. That is, the inlet 271 and the outlet 272 are arranged on the same straight line parallel to the top-bottom direction. For example, the inlet 271 is provided at a lower end of the cooling fluid passage 270, and the outlet 272 is provided at an upper end of the cooling fluid passage 270. Alternatively, the inlet 271 may be provided at the upper end of the cooling fluid passage 270 and the outlet 272 may be provided at the lower end of the cooling fluid passage 270.

As shown in FIGS. 3 and 5, the heat storage tube 230 of the present embodiment includes, as an example, multiple first protrusions 2331 and multiple second protrusions 2332 as the protrusions 233. The first protrusion 2331 protrudes from the base unit 232 toward one side in the cell stacking direction. The second protrusion 2332 protrudes from the base unit 232 toward the other side in the cell stacking direction.

### Cooling Method

Next, a method for cooling each battery cell 220 in the present embodiment will be described. When the eVTOL 100 is flying, that is, during takeoff, cruising, and landing, each battery module 200 mounted on the eVTOL 100 is not connected to the cooling device 400 as shown in FIG. 2. Therefore, the heat of each battery cell 220 is stored in the heat storage material 231 inside the heat storage tube 230. In such manner, the temperature of each battery cell 220 is prevented from rising.

On the other hand, after the landing of the eVTOL 100, each battery module 200 mounted on the eVTOL 100 is connected to the cooling device 400 as shown in FIG. 4. In such manner, the cooling circulation circuit 460 is formed by the battery module 200 and the cooling device 400.

The control device 500 causes the pump 440 to circulate the cooling fluid 600, which has been cooled in advance by the cooling device 400, through the cooling circulation circuit 460. For example, the low-temperature cooling fluid 600 is directed through the second valve joint 250 to the cooling bath 210 and the high-temperature cooling fluid 600 is returned back to the tank 410 of the cooling device 400 through the first valve joint 240. In such case, the pump 440 is controlled to pump the low-temperature cooling fluid 600 through the pipe 430. In such manner, by circulating the cooling fluid 600 through the cooling circulation circuit 460, each battery cell 220 inside the cooling bath 210 is rapidly cooled.

Alternatively, the low-temperature cooling fluid 600 may be introduced to the cooling bath 210 via the first valve joint 240, and the high-temperature cooling fluid 600 may be returned to the tank 410 of the cooling device 400 through the second valve joint 250 of the cooling bath 210. In such manner, the low-temperature cooling fluid 600 flows along the surfaces of each battery cell 220 and each heat storage tube 230, thereby making it possible to cool the multiple battery cells 220 evenly and with high efficiency. In such case, the pump 440 is controlled to pump the low-temperature cooling fluid 600 through the pipe 420.

Thereafter, before the eVTOL 100 takes off, the control device 500 causes the pump 440 to discharge at least a part of the cooling fluid 600 in the cooling bath 210 through the cooling circulation circuit 460. For example, the cooling fluid 600 in the cooling bath 210 is returned to the tank 410 of the cooling device 400 via the first valve joint 240. In such case, the pump 440 is controlled to suck the cooling fluid 600 in the pipe 420.

Before the eVTOL 100 takes off, the control device 500 may discharge the cooling fluid 600 entirely from the cooling bath 210 or may discharge a part of the cooling fluid 600 from the cooling bath 210. As an example, in the present embodiment, the control device 500 discharges the cooling fluid 600 entirely from the cooling bath 210.

### Flight Pattern

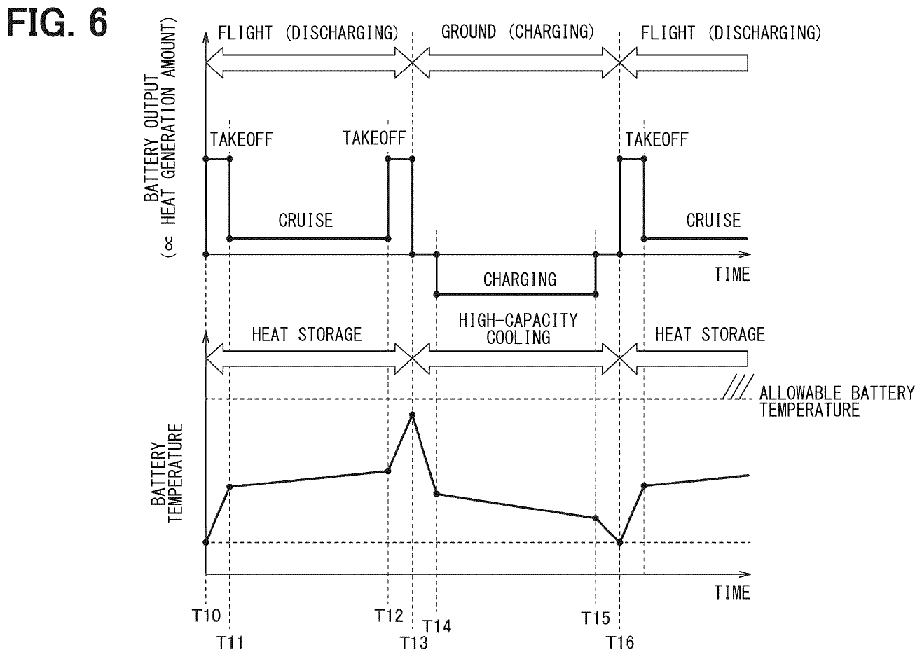

FIG. 6 shows an example of the most simplified flight pattern for the eVTOL 100 from takeoff to landing. The flight patterns of electric flying objects other than the eVTOL 100 are the same as those of the eVTOL 100.

A period from time T10 to time T11 is referred to as a takeoff period, a takeoff time, a departure period, a departure time, or the like. Hereinafter, the period from time T10 to time T11 will be referred to as a takeoff time. The takeoff time refers to an ascend in which the eVTOL 100 moves from a landed position to a cruising altitude. The period from time T11 to time T12 is referred to as a cruising period, a cruising time, or the like. The period from time T12 to time T13 is referred to as a landing period, a landing time, an arrival period, an arrival time, or the like. Hereinafter, the period from time T12 to time T13 will be referred to as a landing time. The landing time refers to a descent of the eVTOL 100 from a cruising altitude to landing on the ground at a destination. For convenience, the required electric power, that is, the output, is assumed to be constant for each period in FIG. 6.

During the period from time T10 to time T11, the eVTOL 100 ascends from a takeoff point to the altitude of a cruise start point. The eVTOL 100 cruises at a predetermined altitude during the period from time T11 to time T12. During the period from time T12 to time T13, the eVTOL 100 descends from the altitude at a cruise end point at time T12 to the landing point.

The movement of the eVTOL 100 primarily includes a horizontal component during cruise and primarily includes a vertical component during takeoff and landing. During takeoff and landing, when moving in the top-bottom direction, a higher output power than during cruising is required for driving the rotor 130 of the eVTOL 100 for a predetermined continuous period of time.

Such a high output puts a heavy load on the battery cells 220 and the EPU 150, which are driving devices for driving the rotor 130. For example, the amount of heat generated by each battery cell 220 increases compared to cruising, causing the temperature to rise. This is because the heat generated by each battery cell 220 is proportional to the output.

After the landing of the eVTOL 100, each battery cell 220 is charged on the ground. Once each battery cell 220 is fully charged, the eVTOL 100 takes off again and begins cruising.

When the eVTOL 100 is in flight (discharging) and on the ground (charging), the battery temperature of each battery cell 220 changes as follows: First, during takeoff, the battery temperature of each battery cell 220 rises rapidly. Because the battery output required during cruising is not as high as during takeoff, the battery temperature of each battery cell 220 rises gradually. Because the same battery output is required during landing as during takeoff, the battery temperature of each battery cell 220 rises rapidly.

During the flight (discharging) period from time T10 to time T13, i.e., from the takeoff to the landing of the eVTOL 100, the heat storage material 231 in the heat storage tube 230 stores and cools the heat of battery cell 220.

In such manner, it is possible to suppress an increase in the battery temperature of the battery cells 220. Therefore, at time T13 when the landing of the eVTOL 100 is complete, the battery temperature of each battery cell 220 is prevented from exceeding the allowable battery temperature.

The period from time T13 to time T16 is a ground (i.e., charging) period during which each battery cell 220 is charged on the ground and each battery cell 220 undergoes high-capacity cooling. First, at time T13, the cooling device 400 is attached to the cooling bath 210 of each battery module 200 of the eVTOL 100. In such manner, as described above, the low-temperature cooling fluid 600 circulates through the cooling circulation circuit 460, causing the battery temperature to drop rapidly.

Further, between time T13 and time T14, the bus bar of the battery module 200 is connected to a charging equipment. When the battery module 200 is connected to the cooling device 400, the bus bar of the battery module 200 may be connected to the charging equipment at the same time. The charging equipment may be included in the cooling device 400 or may be provided separately from the cooling device 400.

Charging of each battery cell 220 begins at time T14. In such manner, each battery cell 220 generates heat, and the decrease in battery temperature becomes gradual. When charging of each battery cell 220 is complete at time T15, each battery cell 220 and the bus bars no longer generate heat, and the battery temperature drops rapidly due to cooling by the low-temperature cooling fluid 600. Thus, high-capacity cooling for each battery cell 220 is complete at time T16.

Then, after the high-capacity cooling is complete at time T16, the cooling fluid 600 is discharged from the cooling bath 210 of each battery module 200 of the eVTOL 100. After time T16, the flight (i.e., discharging) and ground (i.e., charging) from time T10 to time T16 are repeated.

As described above, the battery module 200 of the present embodiment includes (a) the heat storage tube 230 provided at a position between adjacent battery cells 220, and (b) the valve joints 240, 250 to which the cooling device 400 that supplies the cooling fluid 600 to the cooling bath 210 is detachably attached.

According to the above, when the cooling device 400 is not connected to the valve joints 240, 250, heat storage cooling is performed in which the heat of each battery cell 220 is absorbed by the heat storage tube 230. On the other hand, when the cooling device 400 is connected to the valve joints 240, 250, immersion cooling is performed in which the battery cells 220 are immersed in the cooling fluid 600 and cooled. Therefore, simply by attaching and detaching the cooling device 400 to and from the valve joints 240, 250, the cooling method for the battery cells 220 can be switched, and the cooling capacity for the battery cells 220 can be adjusted. In such manner, the cooling capacity for the battery cells 220 can be easily adjusted.

More specifically, for example, when the eVTOL 100 is in flight, the cooling system 400 is removed from the valve joints 240, 250. On the other hand, the heat generated by each battery cell 220 can be absorbed and cooled by the heat storage material 231 of the heat storage tube 230 that has been cooled to a low temperature in advance. Therefore, when the eVTOL 100 is flying, the cooling device 400 can be removed to reduce weight while suppressing the temperature rise of the battery cells 220.

On the other hand, for example, when the eVTOL 100 is on the ground, it is necessary to cool both of (a) the heat stored in the heat storage material 231 and each battery cell 220 during flight of the eVTOL 100 and (b) the heat generated by rapid charging of each battery cell 220. Therefore, high-performance cooling is required.

In view of the above, regarding the battery module 200 of the present embodiment, the cooling device 400 is attached to the valve joints 240 and 250 when the eVTOL 100 is on the ground. In such manner, the battery cells 220 are cooled by being directly immersed in the cooling fluid 600, thereby enabling high-performance cooling of the heat storage material 231 and the battery cells 220.

Further, in the battery cooling system 300 of the present embodiment, before the eVTOL 100 takes off, the control device 500 causes the pump 440 to discharge the cooling fluid 600 from the cooling bath 210 via the cooling circulation circuit 460. According to the above, when the eVTOL 100 is flying, the cooling fluid 600 is not present in the cooling bath 210, thereby achieving weight reduction.

Further, in the battery module 200 of the present embodiment, the heat storage tube 230 is provided with multiple protrusions 233 that protrude toward adjacent battery cells 220, and the surface of the battery cell 220 and the surface of the heat storage tube 230 are connected via the multiple protrusions 233. Further, the gaps 235 formed between the adjacent protrusions 233 provide the cooling fluid passages 270.

In such manner, the cooling fluid passage 270 is formed between the adjacent battery cells 220 and the heat storage tubes 230. Therefore, when the cooling device 400 is attached to the valve joints 240, 250, the heat exchange efficiency between the battery cell 220 and the cooling fluid 600 can be improved, and the heat exchange efficiency between the heat storage tube 230 and the cooling fluid 600 can also be improved. As a result, the heat storage material 231 and the battery cells 220 can be cooled with even higher efficiency.

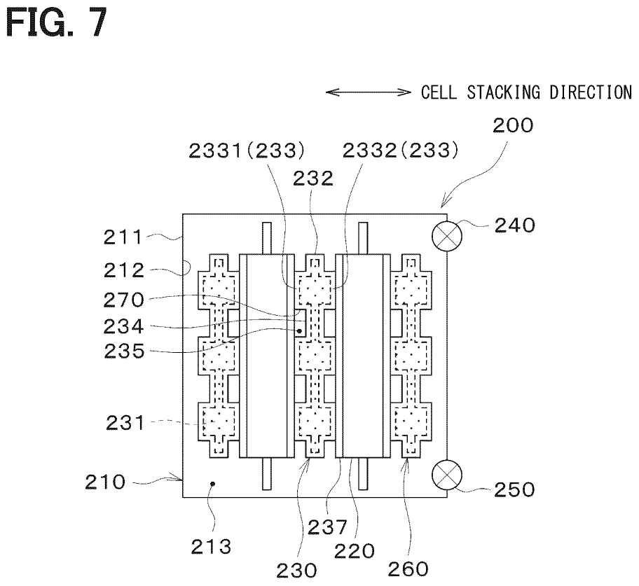

As a modified example, as shown in FIG. 7, a thermally-conductive material 237 may be interposed between the battery cell 220 and the heat storage tube 230 for improving the adhesion between the battery cell 220 and the heat storage tube 230. The thermally-conductive material 237 is generally called as TIM, and is a heat transfer grease, a heat transfer gel, a heat transfer sheet, a heat transfer adhesive, or an adhesive sheet. The TIM is an abbreviation of Thermal Interface Material. As an example, in the present embodiment, a heat transfer sheet is used as the thermally-conductive material 237.

### Second Embodiment

Next, the second embodiment of the present disclosure will be described with reference to the drawings. The second embodiment differs from the first embodiment in the type of cooling fluid 600 and the configuration of the cooling device 400.

In the battery cooling system 300 of the present embodiment, the boiling point of the cooling fluid 600 is lower than the heat-resistant temperature (i.e., the upper limit of the operating temperature) of the battery cells 220. Therefore, the cooling fluid 600 boils by the heat generated by the battery cells 220, and in the cooling bath 210, the cooling fluid boils and absorbs heat from the battery cells 220, thereby performing boil cooling. As an example, in the present embodiment, subcool boiling is performed in which the cooling fluid 600 in the cooling bath 210 boils in a state where the cooling fluid 600 is a subcooled liquid whose temperature is lower than the boiling point.

In the present embodiment, an insulating liquid (i.e., a boiling refrigerant) having a boiling point lower than the heat-resistant temperature of the battery cells 220 is used as the cooling fluid 600. The cooling fluid 600 may be, for example, an insulating liquid that boils at 10 degrees in Celsius to 40 degrees in Celsius. Examples of insulating liquids that boil at 10 degrees in Celsius to 40 degrees in Celsius include Novec (registered trademark) manufactured by 3M, Fluorinert (registered trademark) manufactured by 3M, Galden (registered trademark) manufactured by Solvay, Asahiklin (registered trademark) manufactured by AGC, Opteon (registered trademark) manufactured by Chemours, Solvre (registered trademark) manufactured by Solvex or the like.

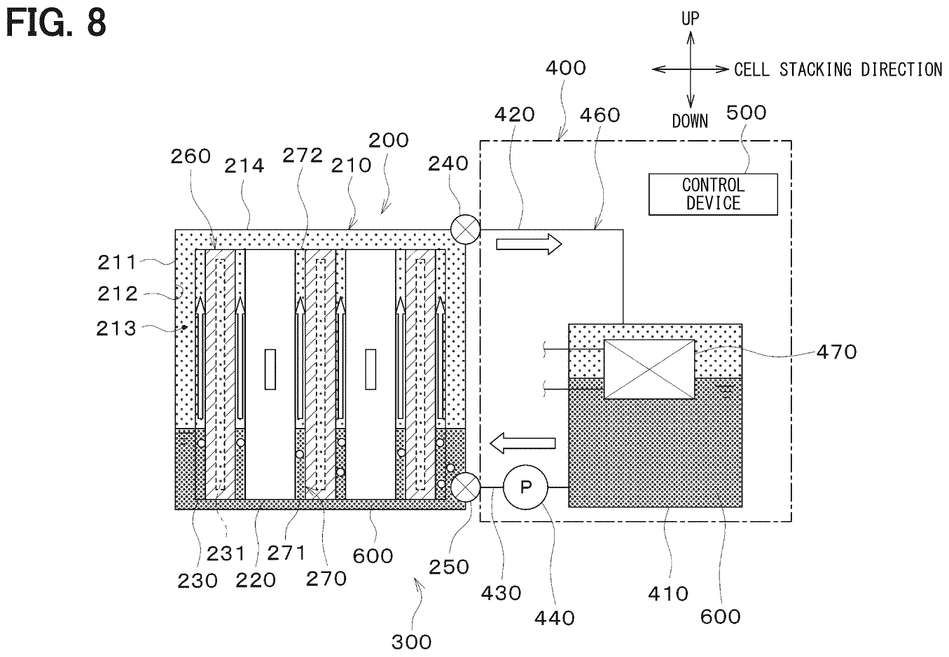

As shown in FIG. 8, in the battery cooling system 300 of the present embodiment, a condenser 470 that condenses the gaseous cooling fluid 600 is provided inside the tank 410 of the cooling device 400. The condenser 470 is a heat exchanger that exchanges heat between the cooling fluid 600 that boils due to heat generated by the battery cells 220 and a heat medium that is lower in temperature than the cooling fluid 600, thereby cooling and condensing the cooling fluid 600.

Next, a method for cooling each battery cell 220 in the present embodiment will be described. The method for cooling each battery cell 220 during flight of the eVTOL 100 is the same as in the first embodiment, thereby a description thereof will be omitted.

After the landing of the eVTOL 100, each battery module 200 mounted on the eVTOL 100 is connected to the cooling device 400 as shown in FIG. 8. In such manner, the cooling circulation circuit 460 is formed by the battery module 200 and the cooling device 400.

The control device 500 causes the pump 440 to circulate the cooling fluid 600, which has been previously turned into a subcooled liquid by the cooling device 400, through the cooling circulation circuit 460. For example, the control device 500 causes the cooling fluid 600, which has become a subcooled liquid, to flow to the cooling bath 210 via the second valve joint 250.

In such manner, inside the cooling bath 210, the cooling fluid 600 boils due to the heat generated by the battery cells 220, and the gas phase cooling fluid 600 is generated. The gas phase cooling fluid 600 produced by boiling rises inside the cooling bath 210, and flows into the tank 410 of the cooling device 400 via the first valve joint 240.

In such case, the pump 440 is controlled to pump the cooling fluid 600 that has become a subcooled liquid to the pipe 430. In such manner, by circulating the cooling fluid 600 through the cooling circulation circuit 460, each battery cell 220 inside the cooling bath 210 is rapidly cooled.

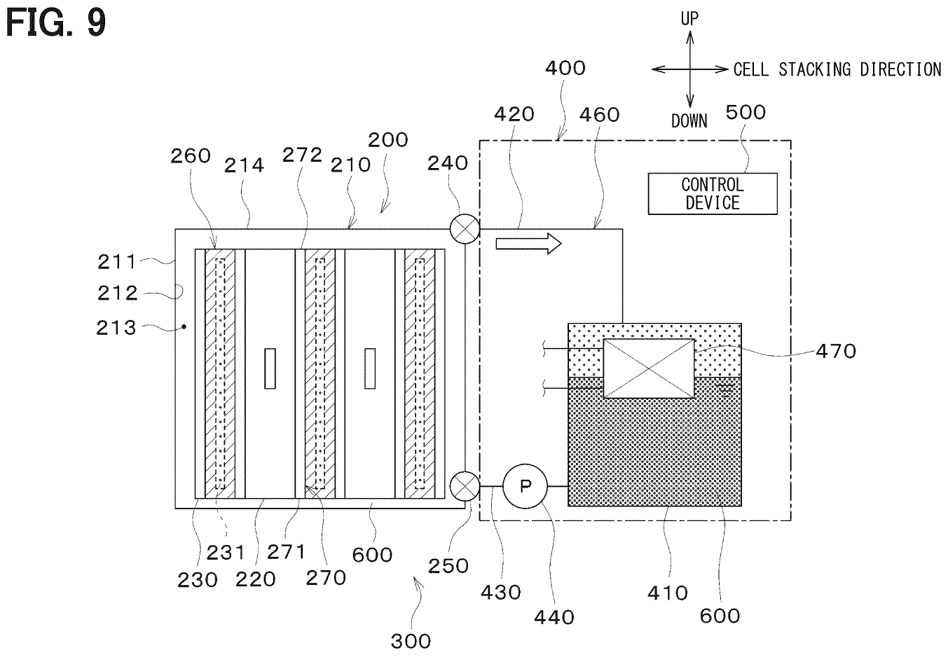

Thereafter, before the takeoff of the eVTOL 100, the control device 500 causes the pump 440 to discharge the cooling fluid 600 from the cooling bath 210 through the cooling circulation circuit 460 as shown in FIG. 9. For example, the control device 500 returns the cooling fluid 600 in the cooling bath 210 to the tank 410 of the cooling device 400 via the first valve joint 240. In such case, the pump 440 is controlled to suck the cooling fluid 600 in the pipe 420. Alternatively, the tank 410 may be positioned below the valve joint 240 that is provided on top of the cooling bath 210, so that the cooling fluid 600 is discharged from the cooling bath 210 toward the tank 410 by gravity.

It is also possible to eliminate the pump 440 and fill the cooling bath 210 with the cooling fluid 600 from the tank 410 by gravity. In such manner, the configuration of the battery cooling system 300 is simplified.

The cooling fluid 600 discharged from the cooling bath 210 flows into the tank 410. Then, the gaseous cooling fluid is then condensed in the condenser 470 and stored in the tank 410.

As described above, in the battery module 200 of the present embodiment, a boiling refrigerant having a boiling point lower than the heat-resistant temperature of the battery cells 220 is used as the cooling fluid 600. Therefore, when the cooling device 400 is attached to the valve joints 240 and 250, the battery cells 220 are put in the cooling fluid 600 for immersion boil cooling. According to the above, boil cooling is performed in priority on the parts of multiple battery cells 220 that are hotter than other parts, thereby making it possible to homogenize the temperature among the multiple battery cells 220.

### Third Embodiment

Next, the third embodiment of the present disclosure will be described with reference to the drawings. The third embodiment differs from the first embodiment in the configuration of the cooling device 400.

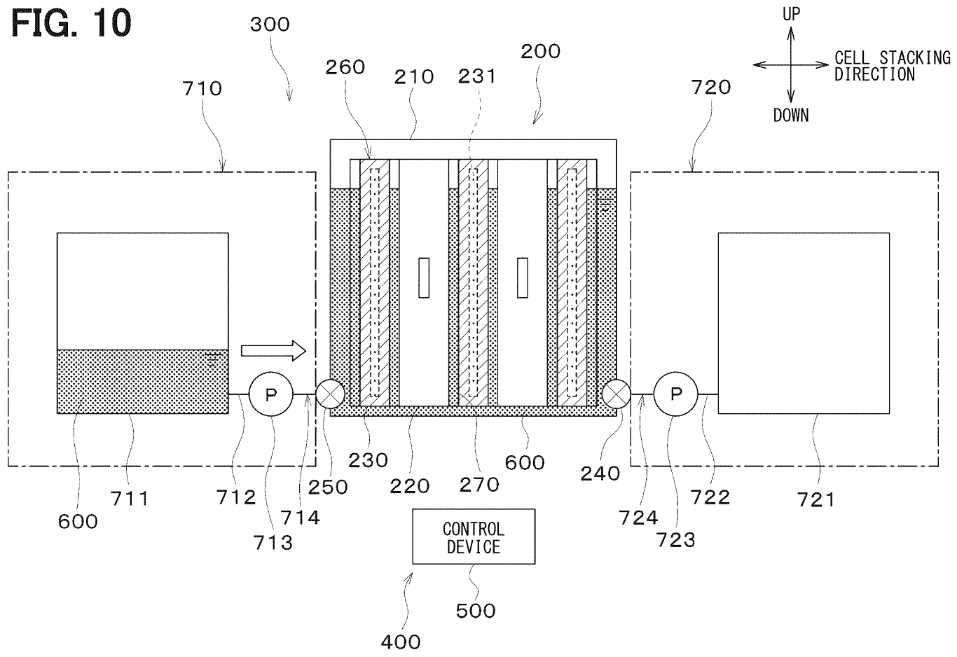

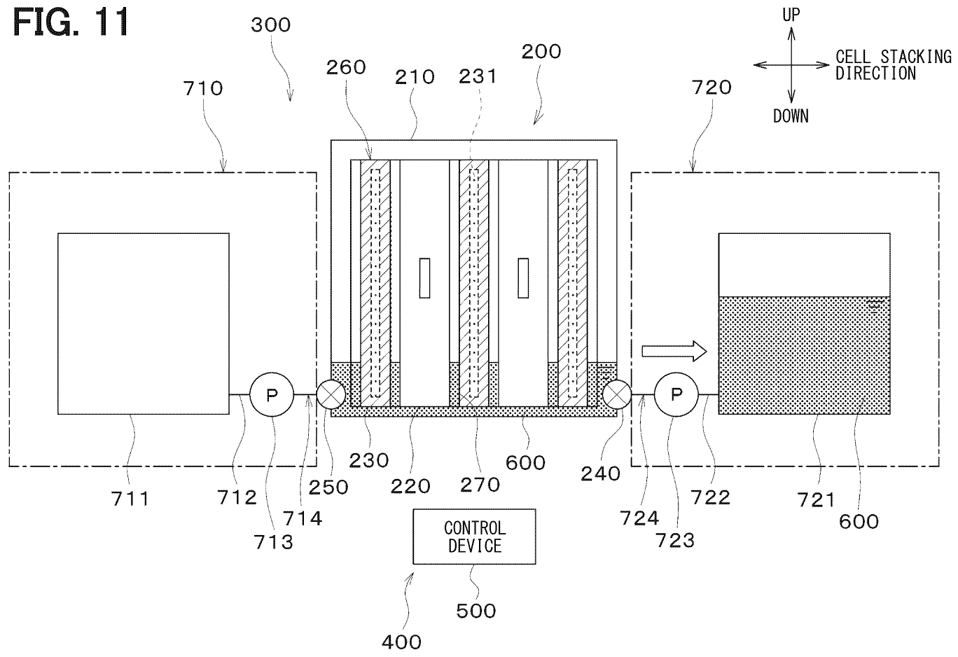

As shown in FIGS. 10 and 11, the battery cooling system 300 of the present embodiment has a cooling fluid supply unit 710 and a cooling fluid recovery unit 720 as the cooling device 400. The cooling fluid supply unit 710 supplies the cooling fluid 600 to the cooling bath 210 of the battery module 200 when the eVTOL 100 is on the ground after landing. The cooling fluid recovery unit 720 recovers the cooling fluid 600 supplied to the cooling bath 210 by the cooling fluid supply unit 710.

In the battery module 200 of the present embodiment, both the first valve joint 240 and the second valve joint 250 are provided below the reference position in the cooling bath 210. The relative positions of the first valve joint 240 and the second valve joint 250 are not particularly limited. In the present embodiment, as an example, the first valve joint 240 and the second valve joint 250 are provided on opposite sides of the cooling bath 210 with the battery pack 260 interposed therebetween.

The cooling fluid supply unit 710 includes a supply tank 711, a supply pipe 712, and a supply pump 713. The operation of the supply pump 713 is controlled by a control signal output from the control device 500.

The supply tank 711 stores the cooling fluid 600. The supply pipe 712 is connected to the supply tank 711. The supply pump 713 pumps the cooling fluid 600 in the supply tank 711 to the supply pipe 712. Although not shown, the cooling fluid supply unit 710 also includes a cooling facility that cools and keeps the temperature of the cooling fluid 600 in the supply tank 711. The supply pipe 712 is, for example, a hose. The supply pipe 712 is connected to the second valve joint 250. In such manner, by connecting the battery module 200 and the cooling fluid supply unit 710 via the second valve joint 250 and the supply pipe 712, a supply flow path 714 is formed, which is a cooling flow path through which the cooling fluid 600 can flow between the battery module 200 and the cooling fluid supply unit 710.

The cooling fluid recovery unit 720 includes a recovery tank 721, a recovery pipe 722, and a recovery pump 723. The operation of the recovery pump 723 is controlled by a control signal output from the control device 500.

The recovery pipe 722 is connected to the first valve joint 240. The recovery pipe 722 is, for example, a hose. The recovery pump 723 sucks the cooling fluid 600 in the cooling bath 210 into the recovery pipe 722. The recovery pipe 722 is connected to the recovery tank 721. The recovery tank 721 stores the cooling fluid 600 discharged from the cooling bath 210. In such manner, by connecting the battery module 200 and the cooling fluid recovery unit 720 via the first valve fitting 240 and the recovery pipe 722, a recovery flow path 724 is formed, which is a cooling flow path through which the cooling fluid 600 can flow between the battery module 200 and the cooling fluid recovery unit 720.

Next, a method for cooling each battery cell 220 in the present embodiment will be described. The method for cooling each battery cell 220 during flight of the eVTOL 100 is the same as in the first embodiment, thereby a description thereof will be omitted.

After the landing of the eVTOL 100, each battery module 200 mounted on the eVTOL 100 is connected to the cooling fluid supply unit 710 as shown in FIG. 10. In such manner, the supply flow path 714 is formed between the battery module 200 and the cooling fluid supply unit 710.

The control device 500 causes the cooling fluid 600, which has been cooled in advance in the cooling fluid supply unit 710, to flow to the supply flow path 714 using the supply pump 713. That is, the low-temperature cooling fluid 600 is allowed to flow to the cooling bath 210 via the second valve joint 250. In such case, the supply pump 713 is controlled to pump the low-temperature cooling fluid 600 to the supply pipe 712. In such manner, by causing the cooling fluid 600 to flow to the supply flow path 714, each battery cell 220 inside the cooling bath 210 is rapidly cooled.

Thereafter, before the takeoff of the eVTOL 100, each battery module 200 mounted on the eVTOL 100 is removed from the cooling fluid supply unit 710 and connected to the cooling fluid recovery unit 720, as shown in FIG. 11. In such manner, the recovery flow path 724 is formed between the battery module 200 and the cooling fluid recovery unit 720.

The control device 500 causes the recovery pump 723 to discharge the cooling fluid 600 from the cooling bath 210 through the recovery flow path 724. That is, the cooling fluid 600 in the cooling bath 210 is caused to flow into the recovery tank 721 of the cooling fluid recovery unit 720 via the first valve joint 240. In such case, the recovery pump 723 is controlled to suck the cooling fluid 600 in the recovery pipe 722.

As described above, in the battery cooling system 300 of the present embodiment, the cooling device 400 is provided with the cooling fluid supply unit 710 that supplies the cooling fluid 600 to the cooling bath 210 and the cooling fluid recovery unit 720 that recovers the cooling fluid 600 from the cooling bath 210, separately. In such manner, by repeatedly supplying the low-temperature cooling fluid 600 to the cooling bath 210 and recovering the high-temperature cooling fluid 600, the battery cells 220 can be cooled efficiently. Additionally, a fluid cooling device for cooling the hot cooling fluid 600 recovered from the cooling bath 210 may be provided at a separate position.

### Fourth Embodiment

Next, the fourth embodiment of the present disclosure will be described with reference to the drawings. In the fourth embodiment, the shape of some of the heat storage tubes 230 included in the battery pack 260 is different from that of the first embodiment.

Here, among the multiple heat storage tubes 230 in the battery module 200, the heat storage tube 230 positioned at the center of the cell stacking direction is referred to as a central heat storage tube 230A, and the heat storage tubes 230 positioned on both ends of the cell stacking direction are referred to as end heat storage tubes 230B.

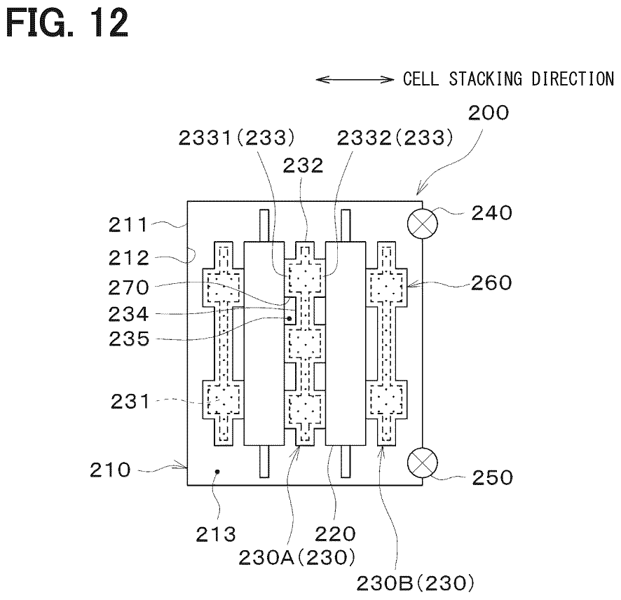

As shown in FIG. 12, in the battery module 200 of the present embodiment, the shape of the central heat storage tube 230A is different from the shape of the end heat storage tubes 230B. In such manner, the amount of heat storage material 231 in the central heat storage tube 230A is different from the amount of heat storage material 231 in the end heat storage tubes 230B.

As an example, in the battery module 200 of the present embodiment, the number of convex portions 233 of the central heat storage tube 230A is greater than the number of convex portions 233 of the end heat storage tube 230B. Further, the amount of heat storage material 231 in the central heat storage tube 230A is greater than the amount of heat storage material 231 in the end heat storage tube 230B.

Generally, among the multiple battery cells 220 that make up the battery pack 260, the battery cell 220 arranged at the center in the cell stacking direction tends to trap heat and have high temperature. In contrast to the above, in the battery module 200 of the present embodiment, the amount of heat storage material 231 in the central heat storage tube 230A is made greater than the amount of heat storage material 231 in the end heat storage tube 230B. In such manner, cooling capacity is reserved for the battery cells 220 at the center of the cell stacking direction, which generate a large amount of heat, while reducing the amount of heat storage material 231 in the end heat storage tube 230B, thereby achieving weight reduction and cost reduction.

### Fifth Embodiment

Next, the fifth embodiment of the present disclosure will be described with reference to the drawings. The fifth embodiment differs from the first embodiment in that fins 280 are provided in place of some of the heat storage tubes 230 included in the battery pack 260.

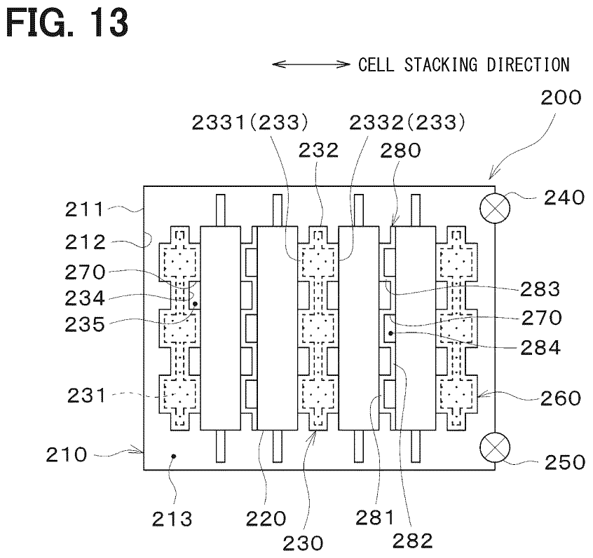

As shown in FIG. 13, the battery module 200 of the present embodiment includes fins 280 arranged at positions between the adjacent battery cells 220. The fins 280 may be corrugated fins made by bending a metal sheet into a wave shape, or offset fins made by partially forming multiple cut-and-raised portions in a metal sheet.

As an example, in the present embodiment, corrugated fins are used as the fins 280. That is, the fins 280 are formed in a wave shape with top surfaces 281 and 282 alternately positioned on one side and the other side in the cell stacking direction.

Here, among the top surfaces 281 and 282 of the fin 280, the one arranged on one side in the cell stacking direction is referred to as a first top surface 281, and the one arranged on the other side in the cell stacking direction is referred to as a second top surface 282. The fin 280 has multiple first top surfaces 281, multiple second top surfaces 282, and multiple side surfaces 283 connecting the first top surfaces 281 and the second top surfaces 282.

The first top surface 281 is in contact with a surface of the battery cell 220 on one side in the cell stacking direction, out of the adjacent battery cells 220. The second top surface 282 is in contact with a surface of the battery cell 220 on the other side in the cell stacking direction, out of the adjacent battery cells 220.

A gap 284 is formed at a position between the adjacent first top surfaces 281 and between the adjacent second top surfaces 282. The gap 284 defines the cooling fluid passage 270. Therefore, the fins 280 of the present embodiment correspond to an example of a flow path forming member.

More specifically, the cooling fluid passage 270 is formed by the gap 284 surrounded by the first top surface 281 of the fin 280, two side surfaces 283 connected to the first top surface 281, and the surface of the battery cell 220 facing the first top surface 281. Further, the cooling fluid passage 270 is formed by the gap 284 surrounded by the second top surface 282 of the fin 280, two side surfaces 283 connected to the second top surface 282, and the surface of the battery cell 220 facing the second top surface 282.

In the present embodiment, the heat storage tube 230 contacts one surface of the battery cell 220 in the cell stacking direction, and the fin 280 contacts the other surface in the cell stacking direction. That is, in the battery pack 260, the heat storage tubes 230 and the fins 280 are arranged alternately one by one.

Note that the side surface 283 of the fin 280 may be provided with a louver (not shown). The louvers are formed by cutting and raising a part of the side surface 283. Therefore, the louvers form communication holes that allow communication between the front and back of the fins 280.

As described above, in the battery module 200 of the present embodiment, the fins 280 are provided at a position between the adjacent battery cells 220. The fins 280 have a cushioning function (i.e., a spring function), and are therefore capable of absorbing volume changes due to the state of charge (SOC), heat generation, and the like of the battery cells 220.

### Sixth Embodiment

Next, the sixth embodiment of the present disclosure will be described with reference to the drawings. The sixth embodiment differs from the fifth embodiment in the shape of the heat storage tubes 230 and the arrangement of the fins 280.

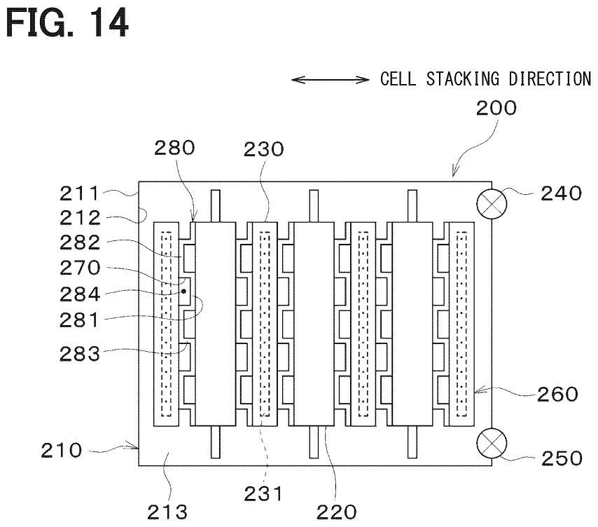

As shown in FIG. 14, in the battery module 200 of the present embodiment, the outer shape of the heat storage tube 230 is formed in a rectangular parallelepiped shape. The surface of the heat storage tube 230 that faces the battery cell 220 is formed in a flat shape that is perpendicular to the cell stacking direction.

In the battery module 200 of the present embodiment, the fins 280 are arranged at positions between the battery cells 220 and the heat storage tubes 230 that are adjacent to each other. The first top surface 281 of the fin 280 is a cell-side connection part that comes into contact with the surface of the battery cell 220. The second top surface 282 of the fin 280 is a heat-storage-side connection part that comes into contact with the surface of the heat storage tube 230.

The surfaces of the adjacent battery cells 220 and the surfaces of the heat storage tubes 230 are connected via the fins 280. More specifically, the surfaces of the battery cells 220 and the surfaces of the heat storage tubes 230 that are adjacent to each other are connected via multiple first top surfaces 281 and multiple second top surfaces 282.

In the present embodiment, the cooling fluid passage 270 is formed by the gap 284 surrounded by the first top surface 281 of the fin 280, two side surfaces 283 connected to the first top surface 281, and the surface of the heat storage tube 230 facing the first top surface 281. Further, the cooling fluid passage 270 is formed by the gap 284 surrounded by the second top surface 282 of the fin 280, two side surfaces 283 connected to the second top surface 282, and the surface of the battery cell 220 facing the second top surface 282.

Here, the first top surface 281 and the second top surface 282 of the fin 280 of the present embodiment correspond to an example of a connection member. That is, the battery cell 220 and the heat storage tube 230 are connected at the first top surface 281 and the second top surface 282, which are connection members. The gap 284 is formed at a position between the battery cell 220 and the heat storage tube 230 in the part of the battery cell 220 and the heat storage tube 230 to which the first top surface 281 or the second top surface 28 is not connected. The cooling fluid passage 270 is configured by the gap 284 formed at a position between the adjacent first top surfaces 281 and by the gap 284 formed at a position between the adjacent second top surfaces 282.

As described above, in the battery module 200 of the present embodiment, the surfaces of the battery cells 220 and the surfaces of the heat storage tubes 230 that are adjacent to each other are connected via the fins 280, and the outer shape of the heat storage tubes 230 is formed into a rectangular parallelepiped shape. In such manner, the configuration of the heat storage tube 230 is simplified, while allowing the fins 280 to absorb volume changes due to the state of charge (SOC), heat generation, or the like of the battery cell 220.

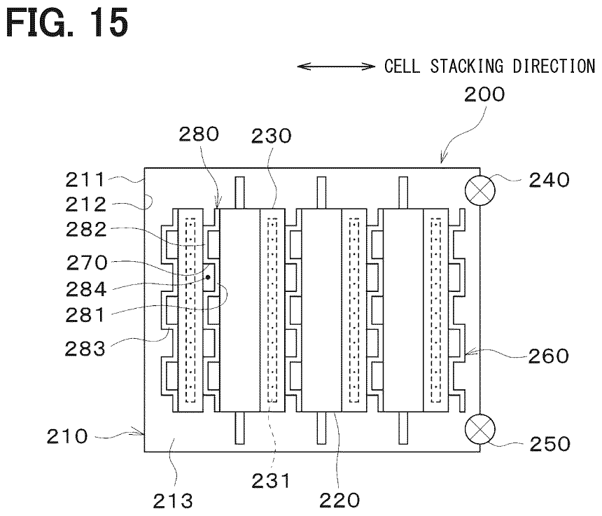

As a modified example, as shown in FIG. 15, the surface on one side of the battery cell 220 in the cell stacking direction may be in direct contact with the heat storage tube 230 without the fin 280 interposed therebetween. In such case, the surface of the battery cell 220 on the other side in the cell stacking direction is in contact with the second top surface 282 of the fin 280.

The present disclosure is not limited to the above-described embodiments, and can be variously modified as follows within the scope that does not deviate from the gist of the present disclosure.

(1) For example, in the above-described embodiment, an example is described in which the cooling fluid passage 270 is formed to penetrate in one direction and extend in the top-bottom direction. However, the shape of the cooling fluid passage 270 is not limited to such an example.

For example, the inlet 271 and the outlet 272 of the cooling fluid passage 270 may be provided at the same position. That is, the cooling fluid passage 270 may be formed so that the cooling fluid 600 makes a U-turn in the cooling fluid passage 270. Further, the cooling fluid passage 270 may be formed to extend in a direction perpendicular to both of the cell stacking direction and the top-bottom direction.

(2) In the above-described embodiment, the control device 500 discharges all of the cooling fluid 600 from the cooling bath 210 before the takeoff of the eVTOL 100. However, the present embodiment is not limited to such an example. For example, the control device 500 may discharge a part of the cooling fluid 600 in the cooling bath 210. According to the above, when the cooling device 400 is removed from the valve joints 240, 250, the heat generated by each battery cell 220 can be absorbed and cooled not only by the heat storage material 231 of the heat storage tube 230 but also by the cooling fluid 600 remaining in the cooling bath 210.

(3) Further, in the above-described embodiment, an example is described in which at least a part of the cooling fluid 600 in the cooling bath 210 is discharged via the cooling circulation circuit 460 by the pump 440 before the takeoff of the eVTOL 100. However, the method of discharging the cooling fluid 600 is not limited to such an example. For example, the tank 410 may be provided at a position below the first valve joint 240, for discharging the cooling fluid 600 from the cooling bath 210 toward the tank 410 by gravity.

(4) Further, in the first embodiment described above, an example is described in which one heat storage tube 230 is provided at a position between a pair of the adjacent battery cells 220. However, the arrangement of the heat storage tubes 230 is not limited to such an example. For example, one heat storage tube 230 may be arranged adjacent to two battery cells 220 arranged in parallel. In such case, the heat storage tube 230 is in contact with one surface of the battery cell 220 in the cell stacking direction, and the heat storage tube 230 is not in contact with the other surface of the battery cell 220 in the cell stacking direction.

(5) Further, in the fifth embodiment described above, an example is described in which the amount of heat storage material 231 in the central heat storage tube 230A is greater than the amount of heat storage material 231 in the end heat storage tube 230B. However, the amount of heat storage material 231 enclosed in the tubes is not limited to such an example. For example, the amount of heat storage material 231 in the heat storage tube 230 that is adjacent to each battery cell 220 may be optimized according to the amount of heat generated by each battery cell 220. In such manner, weight reduction and cost reduction of the battery module are achievable.

(6) Further, in the first to fifth embodiments described above, an example in which the heat storage tube 230 is provided with multiple protrusions 233 has been described. However, the present embodiment is not limited to such an example. For example, the battery cell 220 may be provided with a protrusion that protrudes toward the heat storage tube 230.

Technical features of the battery module and the battery cooling system disclosed in the present specification will be described as follows.

### Item 1

A battery module includes: a plurality of battery cells (220); an accommodation part (210) accommodating the battery cells; a heat storage part (230) provided at a position between the battery cells, which are adjacent to each other, and configured to exchange heat with the battery cells and store heat of the battery cells; a valve joint (240, 250) provided to the accommodation part, the valve joint detachable and attachable to a cooling device (400), which is configured to supply cooling fluid (600) to the accommodation part; and a cooling fluid passage (270) provided at a position between the battery cell and the heat storage part, which are adjacent to each other, the cooling fluid passage configured to allow cooling fluid, which is supplied to the accommodation part, to flow therethrough. The battery cell and the heat storage part are connected with each other via at least two connection members (233, 281, 282). A portion of the battery cell and a portion of the heat storage part, which are not connected with each other via the connection members, define a gap (235, 284) therebetween. The gap defined between the connection members, which are adjacent to each other, form the cooling fluid passage.

### Item 2

The battery module according to item 1, in which the heat storage part includes a non-contact surface (234) facing the battery cell and is not in contact with the battery cell, and a plurality of protrusions (233) protruding from the non-contact surface toward the battery cell and is in contact with a surface of the battery cell, in which the connection members include the protrusions, and the protrusions, which are adjacent to each other, therebetween define the gap (235) forming the cooling fluid passage.

### Item 3

The battery module according to item 1, further includes: a flow path forming member (280) provided between the battery cell and the heat storage part, the flow path forming member (280) including a plurality of cell-side connection parts (281), which are in contact with the battery cell, and a plurality of heat-storage-side connection parts (282), which are in contact with the heat storage part, in which the connection members include the cell-side connection parts and the heat-storage-side connection parts, the cell-side connection parts, which are adjacent to each other, therebetween define the gap (284) forming the cooling fluid passage, and the heat-storage-side connection parts, which are adjacent to each other, therebetween define the gap (284) forming the cooling fluid passage.

### Item 4

The battery module according to any one of items 1 to 3, in which the cooling fluid is an insulating liquid having a boiling point lower than a heat-resistant temperature of the battery cell.

### Item 5

The battery module according to any one of items 1 to 4, in which the cooling fluid passage has an inlet (271) configured to allow cooling fluid to flow into the cooling fluid passage therethrough, and an outlet (272) configured to allow cooling fluid to flow out of the cooling fluid passage therethrough, and the inlet and the outlet are provided at different positions.

### Item 6

The battery module according to any one of items 1 to 5, in which the cooling fluid passage extends in a direction of gravity.

### Item 7

A battery cooling system includes: a battery module (200) including a plurality of battery cells (220), an accommodation part (210) accommodating the battery cells, a heat storage part (230) provided at a position between the battery cells, which are adjacent to each other, and configured to exchange heat with the battery cells and store heat of the battery cells, and a valve joint (240, 250) provided to the accommodation part, the valve joint detachable and attachable to a cooling device (400), which is configured to supply cooling fluid (600) to the accommodation part; the cooling device configured to cool and store cooling fluid; and a control device (500) configured to control the cooling device. The battery module and the cooling device are configured to, when connected with each other via the valve joint, form a cooling circulation circuit (460) that is configured to circulate cooling fluid between the battery module and the cooling device. The control device is configured to circulate cooling fluid, which is cooled in advance by the cooling device, through the cooling circulation circuit, and after circulating cooling fluid, discharge at least a part of cooling fluid in the accommodation part through the cooling circulation circuit.

### Item 8

A battery cooling system includes: a battery module (200) including a plurality of battery cells (220), an accommodation part (210) accommodating the battery cells, a heat storage part (230) provided at a position between the battery cells, which are adjacent to each other, and configured to exchange heat with the battery cells and store heat of the battery cells, and a valve joint (240, 250) provided to the accommodation part, the valve joint detachable and attachable to a cooling device (400), which is configured to supply cooling fluid (600) to the accommodation part; the cooling device configured to cool and store cooling fluid; and a control device (500) configured to control the cooling device. The battery module and the cooling device are configured to, when connected with each other via the valve joint, form a cooling flow path (714, 724) that is configured to allow cooling fluid to flow between the battery module and the cooling device. The control device is configured to fill the battery module with cooling fluid, which is cooled in advance by the cooling device, from the cooling device through the cooling flow path, and after filling of cooling fluid, discharge at least a part of cooling fluid in the accommodation part through the cooling flow path.

Although the present disclosure has been described with reference to the embodiments, it is understood that the present disclosure is not limited to those embodiments or structures. The present disclosure includes various modifications or deformations within a range of equivalents. Further, the various other combinations and configurations, including one or more additional elements, more than that, or less than that, are also within the spirit and scope of the present disclosure.

What is claimed is

1. A battery module comprising:
a plurality of battery cells;
an accommodation part accommodating the battery cells;
a heat storage part provided at a position between the battery cells, which are adjacent to each other, and configured to exchange heat with the battery cells by being in contact with the battery cells and store heat of the battery cells;
a valve joint provided to the accommodation part, the valve joint detachable and attachable to a cooling device, which is configured to supply cooling fluid to the accommodation part; and
a cooling fluid passage provided at a position between the battery cell and the heat storage part, which are adjacent to each other, the cooling fluid passage configured to allow cooling fluid, which is supplied to the accommodation part, to flow therethrough, wherein
the battery cell and the heat storage part are connected with each other via at least two connection members,
a portion of the battery cell and a portion of the heat storage part, which are not connected with each other via the connection members, define a gap therebetween,
the gap defined between the connection members, which are adjacent to each other, form the cooling fluid passage, and
the cooling fluid passage is configured to cause cooling fluid to be in direct contact with both the battery cell and the heat storage part.

2. The battery module according to claim 1, wherein
the heat storage part includes
a non-contact surface facing the battery cell and is not in contact with the battery cell, and
a plurality of protrusions protruding from the non-contact surface toward the battery cell and is in contact with a surface of the battery cell, wherein
the connection members include the protrusions, and
the protrusions, which are adjacent to each other, therebetween define the gap forming the cooling fluid passage.

3. The battery module according to claim 1, further comprising:
a flow path forming member provided between the battery cell and the heat storage part, the flow path forming member including a plurality of cell-side connection parts, which are in contact with the battery cell, and a plurality of heat-storage-side connection parts, which are in contact with the heat storage part, wherein
the connection members include the cell-side connection parts and the heat-storage-side connection parts,
the cell-side connection parts, which are adjacent to each other, therebetween define the gap forming the cooling fluid passage, and
the heat-storage-side connection parts, which are adjacent to each other, therebetween define the gap forming the cooling fluid passage.

4. The battery module according to claim 1, wherein
the cooling fluid is an insulating liquid having a boiling point lower than a heat-resistant temperature of the battery cell.

5. The battery module according to claim 1, wherein
the cooling fluid passage has
an inlet configured to allow cooling fluid to flow into the cooling fluid passage therethrough, and
an outlet configured to allow cooling fluid to flow out of the cooling fluid passage therethrough, and
the inlet and the outlet are provided at different positions.

6. The battery module according to claim 1, wherein
the cooling fluid passage extends in a direction of gravity.

7. A battery cooling system comprising:
a battery module including
a plurality of battery cells,
an accommodation part accommodating the battery cells,
a heat storage part provided at a position between the battery cells, which are adjacent to each other, and configured to exchange heat with the battery cells by being in contact with the battery cells and store heat of the battery cells,
a valve joint provided to the accommodation part, the valve joint detachable and attachable to a cooling device, which is configured to supply cooling fluid to the accommodation part, and
a cooling fluid passage provided at a position between the battery cell and the heat storage part, which are adjacent to each other, the cooling fluid passage configured to allow cooling fluid, which is supplied to the accommodation part, to flow therethrough;
the cooling device configured to cool and store cooling fluid; and
at least one of (i) a circuit and (ii) a processor with a memory storing computer program code executable by the processor, the at least one of the circuit and the processor configured to control the cooling device, wherein the battery module and the cooling device are configured to, when connected with each other via the valve joint, form a cooling circulation circuit that is configured to circulate cooling fluid between the battery module and the cooling device, and
the at least one of the circuit and the processor is further configured to
circulate cooling fluid, which is cooled in advance by the cooling device, through the cooling circulation circuit, and
after circulating cooling fluid, discharge at least a part of cooling fluid in the accommodation part through the cooling circulation circuit,
the battery cell and the heat storage part are connected with each other via at least two connection members,
a portion of the battery cell and a portion of the heat storage part, which are not connected with each other via the connection members, define a gap therebetween,
the gap defined between the connection members, which are adjacent to each other, form the cooling fluid passage, and
the cooling fluid passage is configured to cause cooling fluid to be in direct contact with both the battery cell and the heat storage part.

8. A battery cooling system comprising:
a battery module including
a plurality of battery cells,
an accommodation part accommodating the battery cells,
a heat storage part provided at a position between the battery cells, which are adjacent to each other, and configured to exchange heat with the battery cells by being in contact with the battery cells and store heat of the battery cells,
a valve joint provided to the accommodation part, the valve joint detachable and attachable to a cooling device, which is configured to supply cooling fluid to the accommodation part, and
a cooling fluid passage provided at a position between the battery cell and the heat storage part, which are adjacent to each other, the cooling fluid passage configured to allow cooling fluid, which is supplied to the accommodation part, to flow therethrough;
the cooling device configured to cool and store cooling fluid; and
at least one of (i) a circuit and (ii) a processor with a memory storing computer program code executable by the processor, the at least one of the circuit and the processor configured to control the cooling device, wherein the battery module and the cooling device are configured to, when connected with each other via the valve joint, form a cooling flow path that is configured to allow cooling fluid to flow between the battery module and the cooling device, and
the at least one of the circuit and the processor is further configured to
fill the battery module with cooling fluid, which is cooled in advance by the cooling device, from the cooling device through the cooling flow path, and
after filling of cooling fluid, discharge at least a part of cooling fluid in the accommodation part through the cooling flow path,
the battery cell and the heat storage part are connected with each other via at least two connection members,
a portion of the battery cell and a portion of the heat storage part, which are not connected with each other via the connection members, define a gap therebetween,
the gap defined between the connection members, which are adjacent to each other, form the cooling fluid passage, and
the cooling fluid passage is configured to cause cooling fluid to be in direct contact with both the battery cell and the heat storage part.
